(19) United States
(12) Patent Application Publication
(10) Pub. No.: US 2012/0305352 A1
(43) Pub. Date: Dec. 6, 2012

(54) DOUBLE SLIDING PISTON VALVE

(76) Inventors: Chun Sung YU, Jeonbuk (KR); Wan Sang Park, Jeonbuk (KR)

(21) Appl. No.: 13/483,477

(22) Filed: May 30, 2012

(30) Foreign Application Priority Data
Jun. 3, 2011 (KR) 10-2011-0053938

(51) Int. Cl. F16F 9/34; F16F 9/504

(52) U.S. Cl. 188/275; 188/322.15

(57) ABSTRACT

Disclosed is a double sliding piston valve in which a sliding valve is added to a piston valve to realize gentle variation of damping force. The double sliding piston valve for use in a shock absorber, includes a housing placed in a lower region of a piston to store oil therein, a sliding valve received in the housing, the sliding valve having first and second flow-paths formed therein, pressure springs respectively coming into close contact with upper and lower surfaces of the sliding valve to enable vertical sliding of the sliding valve, and a washer provided below the sliding valve to support the sliding valve, the washer having a center oil hole.

### CROSS-REFERENCE TO RELATED APPLICATION

This application claims the benefit of Korean Patent Application No. 2011-0053938, filed on Jun. 3, 2011 in the Korean Intellectual Property Office, the disclosure of which is incorporated herein by reference.

### BACKGROUND

1. Field

Embodiments of the present invention relate to a double sliding piston valve in which a sliding valve is added to a piston valve to realize gentle variation of damping force.

2. Description of the Related Art

A conventional shock absorber includes a cylinder filled with hydraulic fluid, a piston rod having one end located inside the cylinder and the other end located outside the cylinder, and a piston valve mounted to one end of the piston rod so as to reciprocate within the cylinder.

The cylinder internally defines first and second chambers, which are filled with fluid. The first and second chambers are separated from each other via the piston valve.

In operation of the shock absorber, the piston valve mounted to the distal end of the piston rod reciprocates within the cylinder filled with fluid, generating damping force using a valve device installed thereto.

The conventional shock absorber having one valve exhibits rapid variation of damping force when increasing from a low speed state. This variation may have a negative effect on a ride comfort, causing driving not satisfying passenger demand.

Further, the conventional shock absorber may be greatly restricted in terms of adjusting damping characteristics.

### SUMMARY

Therefore, it is an aspect of the present invention to provide a double sliding piston valve in which a sliding valve is added to realize gentle variation of damping force of a shock absorber.

Additional aspects of the invention will be set forth in part in the description which follows and, in part, will be obvious from the description, or may be learned by practice of the invention.

In accordance with one aspect of the present invention, a double sliding piston valve includes a housing placed in a lower region of a piston to store oil therein, a sliding valve received in the housing, the sliding valve having first and second flow-paths formed therein, pressure springs respectively coming into close contact with upper and lower surfaces of the sliding valve to enable vertical sliding of the sliding valve, and a washer provided below the sliding valve to support the sliding valve, the washer having a center oil hole, wherein oil moves through the sliding valve under a lo-frequency condition, and the sliding valve blocks the oil hole to prevent movement of oil under a high-frequency condition.

The pressure springs may respectively be provided at upper and lower sides of the sliding valve, and the pressure spring provided at the upper side of the sliding valve may have a lower surface supported by an upper surface of the sliding valve and an upper surface supported by an inner ceiling surface of the housing, and the pressure spring provided at the lower side of the sliding valve may have an upper surface supported by a lower surface of the sliding valve and a lower surface supported by an upper surface of the washer.

Damping force may vary based on the size of the oil hole.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a schematic view illustrating tension of a double sliding piston valve according to an exemplary embodiment of the present invention;

FIG. 2 is a schematic view illustrating compression of the double sliding piston valve according to the exemplary embodiment of the present invention.

### DETAILED DESCRIPTION

Reference will now be made in detail to the embodiment of the present invention, examples of which are illustrated in the accompanying drawings, wherein like reference numerals refer to like elements throughout. However, the disclosure is not limited to the embodiments.

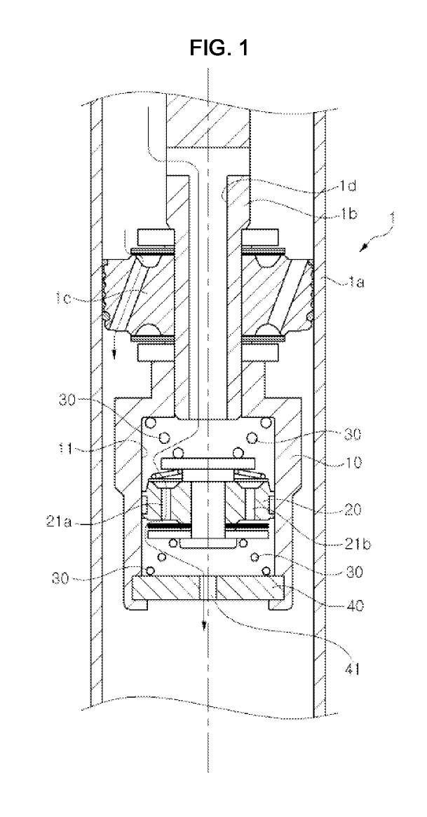

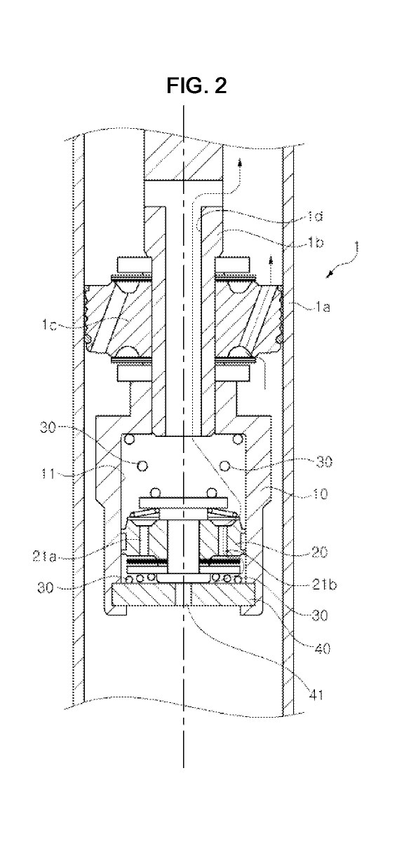

FIG. 1 is a schematic view illustrating tension of a double sliding piston valve according to an exemplary embodiment of the present invention, and FIG. 2 is a schematic view illustrating compression of the double sliding piston valve according to the exemplary embodiment of the present invention.

As illustrated in FIGS. 1 and 2, the double sliding piston valve for use in a shock absorber includes a housing 10 placed in a lower region of a piston 1 to store oil therein, a sliding valve 20 received in the housing 10, the sliding valve 20 having first and second flow-paths 21a and 21b formed therein, a pair of pressure springs 30 respectively coming into close contact with upper and lower surfaces of the sliding valve 20 to enable vertical sliding of the sliding valve 20, and a washer 40 provided below the sliding valve 20 to support the sliding valve 20, the washer 40 having a center oil hole 41.

The piston 1 includes a tube 1a defining an outer wall, a vertical rod 1b received in the tube 1a to extend by a predetermined length, and a main valve 1c formed at any position on the rod 1b.

The housing 10 is located below the main valve 1c within the tube 1a. An oil chamber 11 is defined in the housing 10.

The sliding valve 20 is received in the oil chamber 11 to control flow of oil.

The pressure springs 30 are provided respectively at upper and lower sides of the sliding valve 20. In the case of the pressure spring 30 provided at the upper side of the sliding valve 20, a lower surface thereof comes into close contact with an upper surface of the sliding valve 20, and an upper surface thereof comes into close contact with an inner ceiling surface of the housing 10. In the case of the pressure spring 30 provided at the lower side of the sliding valve 20, an upper surface thereof comes into close contact with a lower surface of the sliding valve 20, and a lower surface thereof comes into close contact with an upper surface of the washer 40. The sliding valve 20 may perform vertical sliding based on the flow rate of oil by elasticity of the pressure springs 30.

The washer 40 is located at a lower end of the housing 10 such that oil is introduced into the oil chamber 11 of the housing 10 through the oil hole 41. Accordingly, the flow rate of oil to be introduced into the housing 10 may be adjusted based on the size of the oil hole 41, which enables variation of damping force of the shock absorber.

The damping force of the shock absorber is mainly generated in the main valve 1c. The sliding valve 20 serves to vary the damping force of the shock absorber based on the flow rate of oil introduced. More specifically, referring to FIG. 1, under a low-frequency condition, oil, which has been introduced into the oil chamber 11 through a hole 1d formed in the rod 1b, moves downward through the first flow-path 21a of the sliding valve 20, thereby being discharged through the oil hole 41. Through this oil movement, damping force is alleviated. However, referring to FIG. 2, under a high-frequency condition, the sliding valve 20 blocks the oil hole 41 of the washer 40 to prevent the oil from moving to the oil hole 41. Thereby, the oil from below the oil chamber 11 moves upward through the second flow-path 21b, and continuously moves to an upper region of the piston 1 through the hole 1d of the rod 1b, causing increase in damping force.

As is apparent from the above description, a double sliding piston valve according to the embodiment includes a sliding valve added to an existing valve of a shock absorber, which ensures gentle variation of damping force.

Although the embodiment of the present invention has been shown and described, it would be appreciated by those skilled in the art that changes may be made in these embodiments without departing from the principles and spirit of the invention, the scope of which is defined in the claims and their equivalents.

What is claimed is:

1. A double sliding piston valve for use in a shock absorber, comprising:
a housing placed in a lower region of a piston to store oil therein;
a sliding valve received in the housing, the sliding valve having first and second flow-paths formed therein;
pressure springs respectively coming into close contact with upper and lower surfaces of the sliding valve to enable vertical sliding of the sliding valve; and
a washer provided below the sliding valve to support the sliding valve, the washer having a center oil hole,
wherein oil moves through the sliding valve under a lo-frequency condition, and the sliding valve blocks the oil hole to prevent movement of oil under a high-frequency condition.

2. The double sliding piston valve according to claim 1,
wherein the pressure springs are respectively provided at upper and lower sides of the sliding valve, and
wherein the pressure spring provided at the upper side of the sliding valve has a lower surface supported by an upper surface of the sliding valve and an upper surface supported by an inner ceiling surface of the housing, and the pressure spring provided at the lower side of the sliding valve has an upper surface supported by a lower surface of the sliding valve and a lower surface supported by an upper surface of the washer.

3. The double sliding piston valve according to claim 1, wherein damping force varies based on the size of the oil hole.
